(19) United States
(12) Patent Application Publication
(10) Pub. No.: US 2024/0118639 A1
(43) Pub. Date: Apr. 11, 2024

(54) THERMAL TREATMENT APPARATUS, AND TONER MANUFACTURING METHOD

(71) Applicant: CANON KABUSHIKI KAISHA, Tokyo (JP)

(72) Inventors: TAKESHI OHTSU, Ibaraki (JP); KOH ISHIGAMI, Chiba (JP); KOUICHIROU OCHI, Chiba (JP); YOSUKE IWASAKI, Chiba (JP); DAISUKE YAMASHITA, Chiba (JP); HISASUKE KAJIHARA, Ibaraki (JP)

(21) Appl. No.: 18/477,725

(22) Filed: Sep. 29, 2023

(30) Foreign Application Priority Data
Oct. 7, 2022 (JP) 2022-162449
Sep. 22, 2023 (JP) 2023-159157

(51) Int. Cl. G03G 9/08

(52) U.S. Cl. CPC G03G 9/0815

(57) ABSTRACT

A thermal treatment apparatus includes a treatment tank including a treatment chamber to perform thermal treatment on toner particles; a toner particle supply unit configured to supply toner particles into the treatment chamber; and a hot air supply unit including a supply port to supply hot air into the treatment chamber. The supply port of the hot air supply unit is disposed on a ceiling of the treatment chamber. The treatment tank further includes: a columnar member that is vertically disposed at the center inside of the treatment chamber; and a protruded member that is disposed at an upper end of the columnar member and has an approximately conical shape protruding toward the ceiling. The columnar member has a cylindrical shape and a radius of curvature RCP (mm) of an upper end edge in a vertical cross-section thereof is 5<RCP<75.

### BACKGROUND OF THE INVENTION

### Field of the Invention

The present invention relates to a thermal treatment apparatus used for sphering treatment of toner particles.

### Description of the Related Art

In a manufacturing steps of toner, which is used as developer in an electrophotographic image forming apparatus, thermal treatment to sphere toner particles at a desired circularity (sphering treatment) may be performed. An example of the thermal treatment apparatus to perform sphering treatment generates an air flow of hot air in a treatment chamber of a treatment tank, moves toner particles while being carried by the hot air current inside of the treatment chamber, and changes the circularity of the toner particles to a desired value (Japanese Patent Application Publication No. 2004-276016 and No. 2001-310324).

### SUMMARY OF THE INVENTION

Toner particles in a melted state may adhere to an inner wall surface of the treatment chamber or coalesce together. In some cases, such melt adhesion and coalescence of toner particles affect the productivity to generate toner particles having a desired circularity, and the maintainability of the treatment apparatus. Japanese Patent Application Publication No. 2004-276016 discloses a technique to suppress melt adhesion of the toner particles to an inner wall surface of the treatment chamber by cooling the inner wall surface of the treatment chamber with cooling air. Furthermore, Japanese Patent Application Publication No. 2001-310324 discloses a technique to suppress the dispersion of the sphering and coalescing of toner particles by disposing a curved surface portion having a predetermined shape at an injection port of an injection nozzle, and dispersing toner particles such that toner particles having a larger particle size are supplied to the upstream side of the hot air current compared with toner particles having a smaller particle size.

Melt adhesion of toner particles to the inner wall surface of the treatment chamber may occur when the toner particles in the melted state contact the inner wall surface of the treatment chamber, and the coalescence of toner particles may occur when toner particles remain in the melted state for a long time, whereby the chances of toner particles contacting with each other increases. With the techniques according to Japanese Patent Application Publication No. 2004-276016 and Japanese Patent Application Publication No. 2001-310324, in some cases, toner particles remaining in the melted state cannot be sufficiently prevented.

It is an object of the present invention to provide a technique to suppress the melt adhesion of toner particles and coalescence of toner particles, and to improve the productivity to generate toner particles having a desired circularity using a simple configuration.

To achieve this object, a thermal treatment apparatus according to the present invention includes:
a treatment tank including a treatment chamber to perform thermal treatment on toner particles;
a toner particle supply unit configured to supply toner particles into the treatment chamber; and
a hot air supply unit including a supply port to supply hot air into the treatment chamber, wherein
the supply port of the hot air supply unit is disposed on a ceiling of the treatment chamber, wherein
the treatment tank further including:
a columnar member that is vertically disposed at the center inside of the treatment chamber; and
a protruded member that is disposed at an upper end of the columnar member and has an approximately conical shape protruding toward the ceiling, wherein
the columnar member has a cylindrical shape and a radius of curvature RCP (mm) of an upper end edge in a vertical cross-section thereof is 5<RCP<75.

To achieve the above object, a toner manufacturing method for manufacturing toner by performing thermal treatment on toner particles using a thermal treatment apparatus according to the present invention, wherein
the thermal treatment apparatus includes:
a treatment tank including a treatment chamber to perform thermal treatment on toner particles;
a toner particle supply unit configured to supply toner particles into the treatment chamber; and
a hot air supply unit including a supply port to supply hot air into the treatment chamber, wherein
the supply port of the hot air supply unit is disposed on a ceiling of the treatment chamber, wherein
the treatment tank further including:
a columnar member that is disposed at the center inside of the treatment chamber in a vertical direction; and
a protruded member that is disposed at an upper end of the columnar member and has an approximately conical shape protruding toward the ceiling, wherein
the columnar member has a cylindrical shape and a radius of curvature RCP (mm) of an upper end edge in a vertical cross-section thereof is 5<RCP<75.

According to the present invention, the melt adhesion of toner particles and coalescence of toner particles can be suppressed, and the productivity to generate toner particles having a desired circularity can be improved using a simple configuration.

Further features of the present invention will become apparent from the following description of exemplary embodiments with reference to the attached drawings.

### BRIEF DESCRIPTION OF THE DRAWINGS

FIG. 1 is a schematic diagram depicting a heat sphering apparatus according to Embodiment 1 of the present invention;

FIG. 2 is a cross-sectional view of a treatment tank according to Embodiment 1 of the present invention;

FIG. 3 is a perspective view of the treatment tank according to Embodiment 1 of the present invention;

FIG. 4 is a perspective view of a center pole according to Embodiment 1 of the present invention;

FIG. 5 is a perspective view of the treatment tank according to Embodiment 1 of the present invention;

FIG. 6 is an enlarged perspective view of an upper end area of the center pole according to Embodiment 1 of the present invention;

FIGS. 7A to 7D are cross-sectional views of the treatment tank according to Embodiment 1 of the present invention;

FIGS. 8A and 8B are cross-sectional views of an upper portion of the treatment chamber of the treatment tank according to Comparative Embodiment 1 and Embodiment 1 of the present invention;

FIG. 9 is a schematic diagram indicating the dimensions of each composing element of the treatment tank according to Embodiment 1 of the present invention;

FIG. 10 is a cross-sectional view indicating the dimensions of each composing element of the treatment tank according to Embodiment 1 of the present invention;

FIGS. 11A and 11B are schematic diagrams of a toner supply port and a first cold air supply port according to Embodiment 1 of the present invention;

FIG. 12 is a cross-sectional view of an upper portion of a treatment chamber of a treatment tank according to Embodiment 2 of the present invention;

FIG. 13 is a schematic diagram indicating the dimensions of each composing element of the treatment tank according to Embodiment 2 of the present invention; and

FIG. 14 is a cross-sectional view of the upper portion of a treatment chamber of a treatment tank according to Embodiment 3 of the present invention.

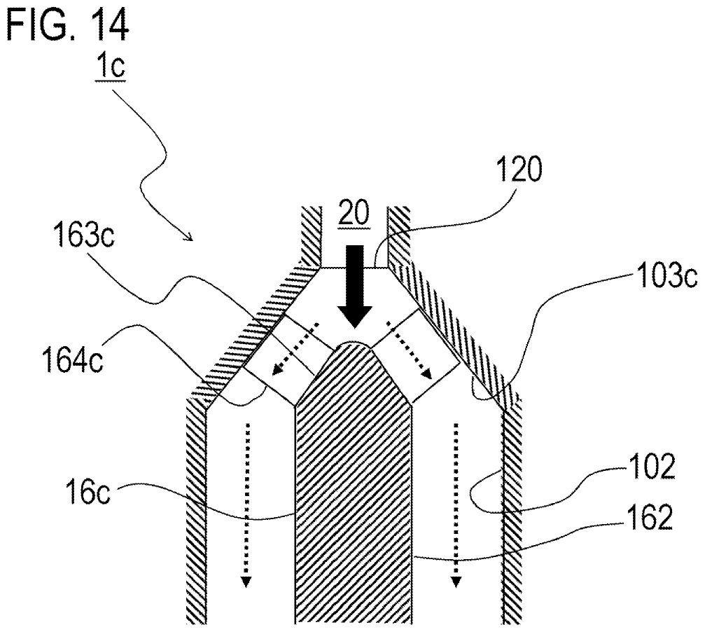

### DESCRIPTION OF THE EMBODIMENTS

Embodiments of the present disclosure will be described using the following examples. The configurations disclosed in the following examples, such as the functions, materials, shapes and relative positions of components, are merely examples related to the claims, and are not intended to limit the claims to the configurations disclosed in these examples. The problems to be solved by the configurations disclosed in these examples or the functions or effects acquired based on the disclosed configurations are not intended to limit the claims.

### Embodiment 1

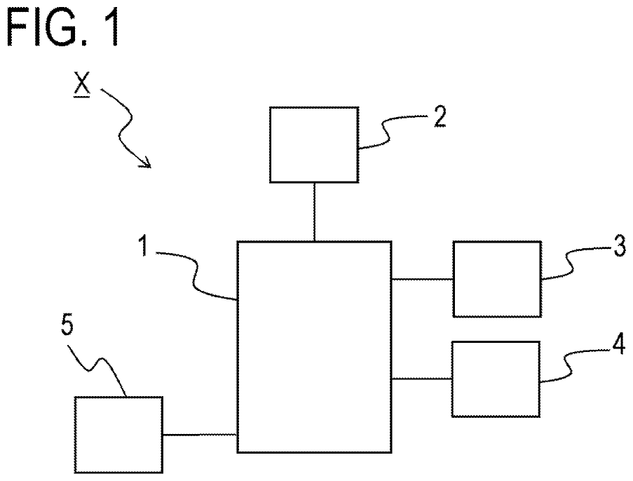

FIG. 1 is a schematic diagram depicting a general configuration of a heat sphering apparatus according to an embodiment of the present invention.

The heat sphering apparatus X according to Embodiment 1 is a thermal treatment apparatus which performs thermal treatment (sphering treatment) to sphere toner particles at a desired circularity in the manufacturing steps of toner, which is used as developer in an electrophotographic image forming apparatus. It is known that the circularity of toner particles influence the transferability of toner in the electrophotographic image forming process and the uniformity of the in-plane gloss of formed images, and sometimes the sphering treatment, to shape the toner particles to have a desired circularity, may be performed to improve image quality.

Configuration of Heat Sphering Apparatus

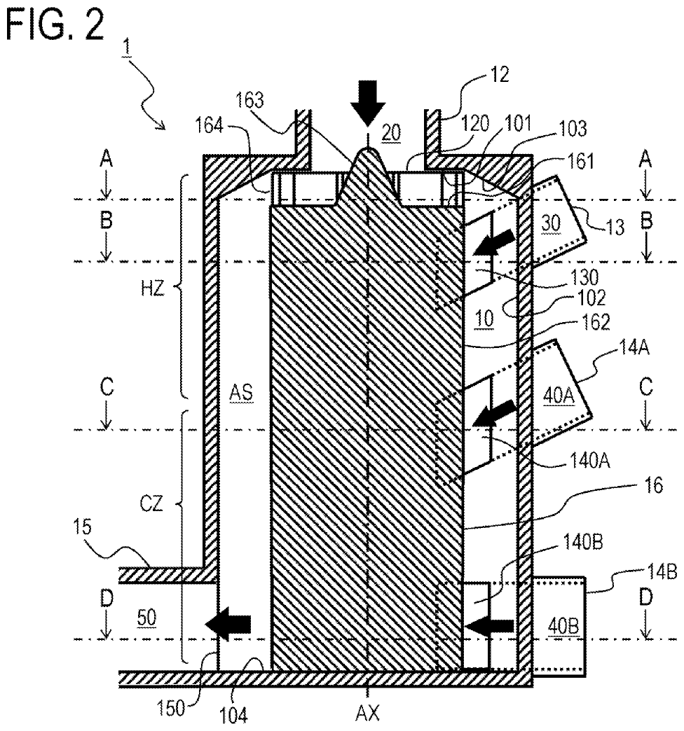

As illustrated in FIG. 1, the heat sphering apparatus X according to Embodiment 1 includes: a treatment tank 1, a hot air supply portion 2, a toner supply portion 3, a cold air supply portion 4, and a toner collection portion 5. The treatment tank 1 includes a treatment chamber 10 (see FIG. 2, etc.) to perform a predetermined heating treatment on toner particles. The hot air supply portion 2 supplies hot air into the treatment chamber 10 of the treatment tank 1 as the hot air supply unit. The toner supply portion 3 supplies toner particles into the treatment chamber of the treatment tank 1 as the toner particle supply unit. The cold air supply portion 4 supplies cold air into the treatment chamber of the treatment tank 1 as the cold air supply unit. The toner collection portion 5 collects thermally treated toner particles from the treatment chamber of the treatment tank 1 as the toner particle collection unit.

A specific configuration of each component of the heat sphering apparatus X according to Embodiment 1 may be the same as a conventionally known heat sphering apparatus, except for the configuration of the treatment tank 1, which will be described later. Therefore description on the specific configuration of the hot air supply portion 2, the toner supply portion 3, the cold air supply portion 4 and the toner collection portion 5 will be omitted. In other words, the specific configuration of each of these components is not limited to a specific configuration, as long as the air flow can be generated inside of the treatment chamber 10 to move the toner particles from the supply port to the collection port, and a thermal treatment zone and a cooling zone can be formed in the moving path of the toner particles, just like a conventional apparatus. Further, the configuration of each component is not limited to a specific configuration, as long as the speed of the air flow, the supply amount and the collection amount of the toner particles, the control temperature of the thermal treatment zone and the cooling zone, and the like can be appropriately controlled.

Configuration of Treatment Tank

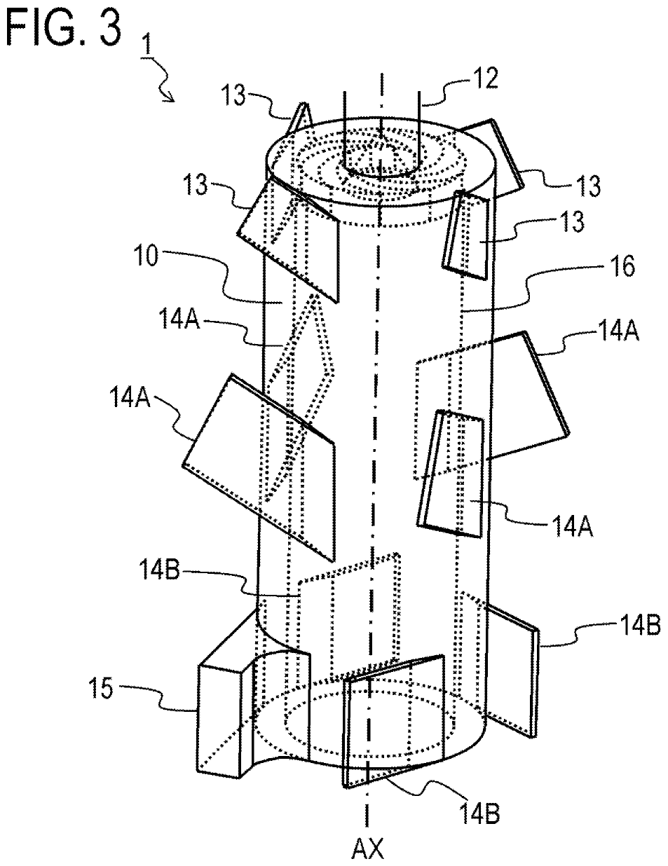

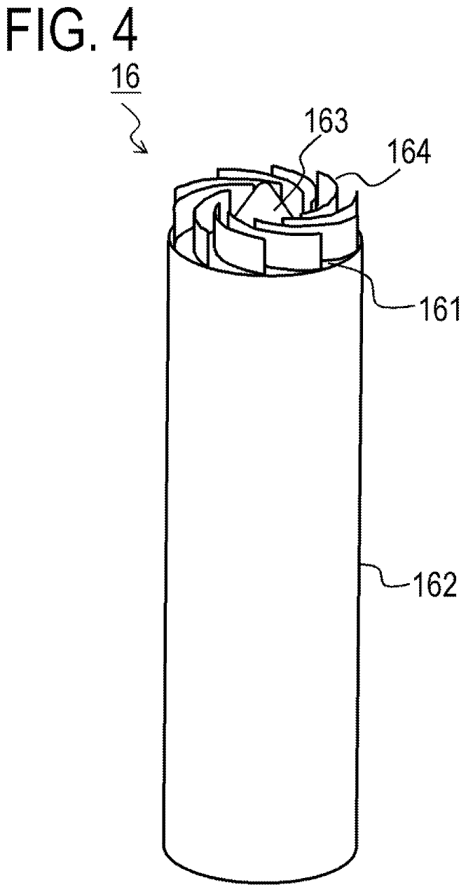

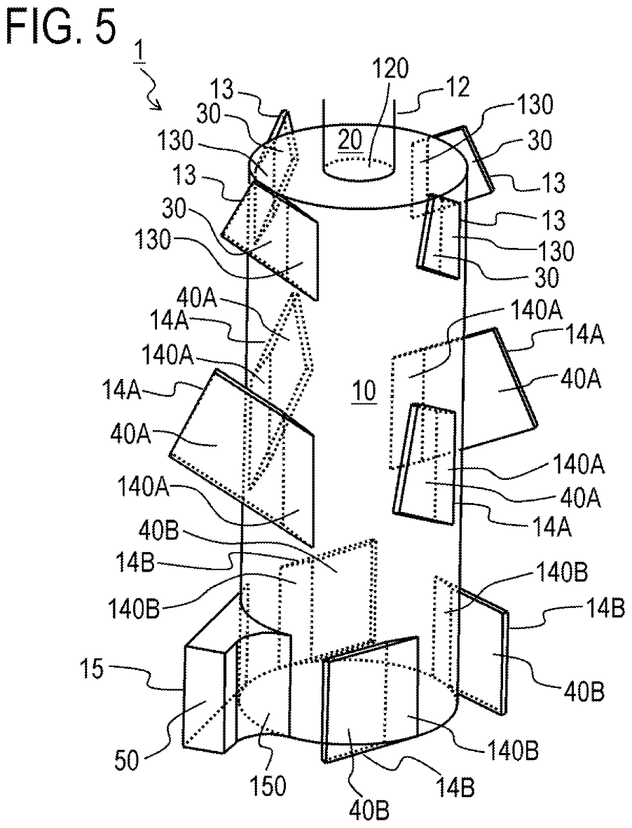

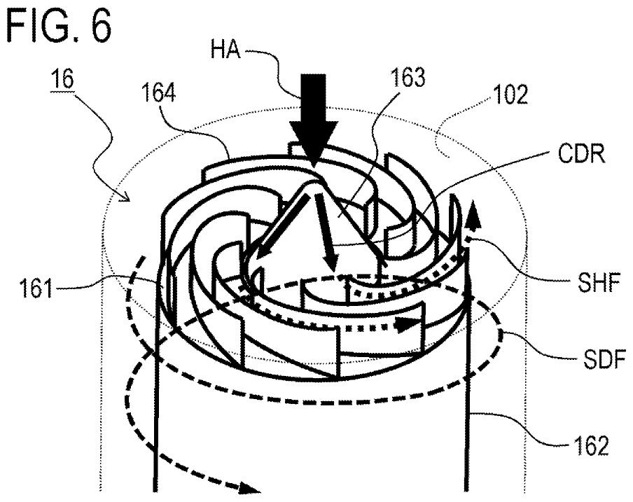

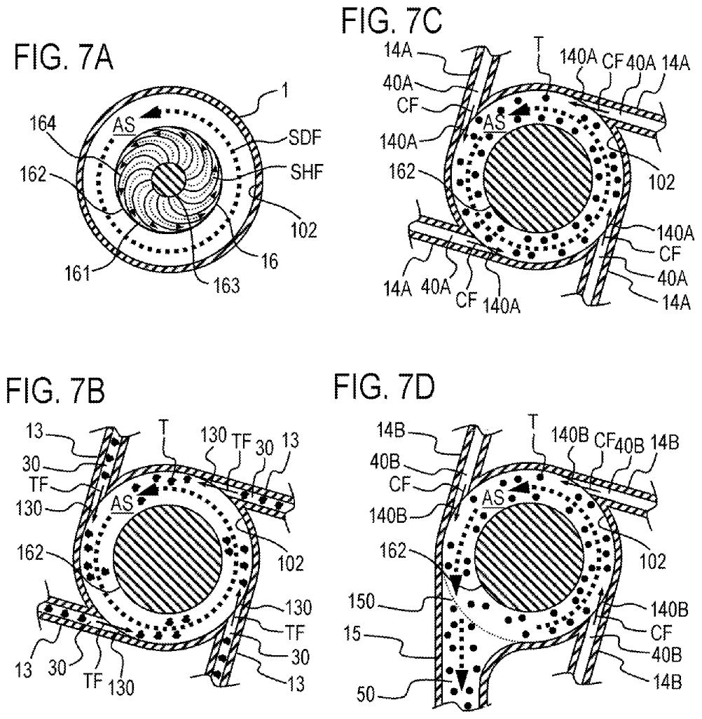

FIG. 2 is a schematic cross-sectional view of the treatment tank 1 according to Embodiment 1. FIG. 3 is a schematic perspective view of the treatment tank 1 according to Embodiment 1. FIG. 4 is a schematic perspective view of a center pole 16 of Embodiment 1, and is a view when the configurations, other than the center pole 16, are omitted in FIG. 3. FIG. 5 is a schematic perspective view of the treatment tank 1 of Embodiment 1, and is a view when the center pole 16 is omitted in FIG. 3. FIG. 6 is a schematic perspective view when the tip (upper end area) of the center pole 16 of Embodiment 1 is enlarged. FIGS. 7A to 7D are schematic cross-sectional views in the horizontal direction of each portion of the treatment tank 1 of Embodiment 1, where FIG. 7A is a cross-sectional view in the arrow AA direction in FIG. 3, FIG. 7B is a cross-sectional view in the arrow BB direction in FIG. 3, FIG. 7C is a cross-sectional view in the arrow CC direction in FIG. 3, and FIG. 7D is a cross-sectional view in the arrow DD direction in FIG. 3.

As illustrated in FIGS. 2 and 3, the treatment tank 1 includes a hot air introducing portion 12, a toner introducing portion 13, a first cold air introducing portion 14A, a second cold air introducing portion 14B, and a toner discharging portion 15. In the treatment chamber 10 of the treatment tank 1, a center pole 16, which is a rectifying member, is disposed vertically. The treatment tank 1 has an approximately cylindrical structure of which center axis line extends in a vertical direction. As illustrated in FIGS. 2 and 3, the center pole 16 is vertically disposed in the treatment chamber 10 such that the center axis line thereof comes to the same axis as the center axis line of the treatment tank 1. In other words, the center axis line AX indicated in FIGS. 2, 3 and the like is both the center axis line of the treatment tank 1 (inner peripheral surface 102 of the treatment chamber 10), and the center axis line of the center pole 16 (cone 163).

An inner wall of the treatment tank 1 constituting the treatment chamber 10 may have a configuration where a top surface 101 and a cylindrical inner peripheral surface (cylindrical surface, side surface) 102, having the center axis line AX which is parallel with the vertical direction, are directly connected. But as illustrated in FIGS. 2 and 3, the configuration preferably includes an inclined surface (tapered surface) 103 between the top surface 101 and the inner peripheral surface 102, connecting the top surface 101 and the inner peripheral surface 102. A bottom surface 104 is on the lower side of the inner peripheral surface in the vertical direction. A hot air supply port 120 is disposed on the top surface 101. On the inner peripheral surface 102, a toner supply port (toner particle supply port) 130, a first cold air supply port 140A, a second cold air supply port 140B, and a toner collection port 150 are disposed.

Hot Air Introducing Portion

As illustrated in FIGS. 2 and 5, the hot air introducing portion 12 constitutes a hot air supply path 20 which guides the hot air supplied from the hot air supply portion 2 into the treatment chamber 10. The hot air supply path 20 extends downward from the upper portion of the treatment tank 1 in the vertical direction, and is connected to the treatment chamber 10 via the hot air supply port 120. The hot air supply port 120 opens at the top surface 101 of the treatment chamber 10. The hot air supply port 120 is a circular opening which is concentric with an approximately circular top surface 101 (inner peripheral surface 102). The hot air supplied from the hot air supply portion 2 is introduced into the treatment chamber 10 such that the hot air is blown down into the treatment chamber 10 from the hot air supply port 120 at the top surface 101 of the treatment chamber 10.

Center Pole

As illustrated in FIGS. 2, 3 and 4, the center pole 16 is a columnar member having an approximately cylindrical shape, and is vertically disposed inside of the treatment chamber 10 coaxially with the inner peripheral surface 102 of the treatment chamber 10, so that the tip thereof faces the hot air supply port 120 in the center axis line AX direction (vertical direction). The center pole 16 is a rectifying member which generates air flow that moves such that the toner particles descend spirally turning inside of the treatment chamber 10.

The center pole 16 includes an upper end surface 161 and an outer peripheral surface (side surface) 162, as illustrated in FIGS. 2 and 4. The upper end surface 161 of the center pole 16 is lower than the top surface 101 of the treatment chamber 10, and faces the top surface 101 and the hot air supply port 120 in the vertical direction. The outer peripheral surface 162 of the center pole 16 has a diameter smaller than that of the inner peripheral surface 102 of the treatment chamber 10, and faces the inner peripheral surface 102 with a predetermined space in the diameter direction. On the upper end surface 161 of the center pole 16, a cone (protruded member) 163 and louvers 164 are disposed. Further, a refrigerant passage (not illustrated) is disposed inside of the center pole 16.

Cone

As illustrated in FIGS. 2, 4 and 6, the cone 163 is an approximately cone-shaped protruded member, which protrudes upward from the upper end surface 161 of the center pole 16. The cone 163 is disposed on the upper end surface 161 of the center pole 16, so as to face the hot air supply port 120 coaxially with the hot air supply port 120. The cone 163 is disposed such that the height of the tip thereof is higher than the top surface 101, and the tip side enters into the hot air supply port 120. It is preferable that an R shape is added to the tip (apex) of the cone 163.

Louvers

As illustrated in FIGS. 2, 4 and 6, the louvers 164 are spirally curved wall portions which are disposed to protrude upward from the upper end surface 161 of the center pole 16. A plurality of louvers 164 are radially disposed so as to surround the outer periphery of the cone 163. Each of the plurality of louvers 164 is disposed from the outer periphery of the lower end of the cone 163 to the outer diameter of the center pole 16 in the diameter direction with respect to the center axis line of the center pole 16, and is curved such that the extending direction gradually changes to the direction along the periphery direction around the center axis line. The plurality of louvers 164 are disposed around the outer periphery of the cone 163 at equal intervals.

As illustrated in FIG. 2, each louver 164 is configured such that the tip thereof contacts with the top surface 101 of the treatment chamber 10. In other words, the louvers 164 constitute a rectifying portion configured such that the space between the upper end surface 161 of the center pole 16 and the top surface 101 of the treatment chamber 10 is partitioned into a plurality of spiral spaces divided in the outer peripheral direction of the cone 163. For the configuration of the treatment tank 1, a top plate constituting the top surface 101 of the treatment chamber 10 is placed on the louvers 164, for example, such that the louvers 164 are disposed between the top plate and the upper end surface 161 of the center pole 16 in the vertical direction. The rectifying function of the cone 163 and the louvers 164 will be described in detail later.

As illustrated in FIGS. 4, 6 and 7, the treatment tank 1 of Embodiment 1 is configured such that the turning direction of the air flow inside of the treatment chamber 10 becomes counterclockwise in the peripheral direction around the center axis line AX when viewed from top to bottom in the center axis line AX direction. Therefore the louvers 164 extend so as to curve more counterclockwise as the location is closer to the outer diameter. Each louver 164 extends in the direction along the diameter direction as the location is closer to the outer periphery of the cone 163, and in the direction along the outer periphery of the upper end surface 161 (outer peripheral surface 162 of the center pole 16) as the location is closer to the outer periphery of the upper end surface 161 of the center pole 16.

The turning direction of the air flow may be configured to be clockwise. In this case, each configuration of the curving directions of the louvers 164, the toner particle supplying direction, the cold air introducing direction, the collecting direction of the thermally treated toner particles, and the like, become the opposite configuration of each portion of the treatment tank 1 of Embodiment 1 respectively.

Toner Introducing Portion

The toner supply portion 3 and the toner introducing portion 13 are configured to allow compressed air to enter into the treatment chamber 10, and carry and introduce toner particles T with the compressed air into the treatment chamber 10. As illustrated in FIGS. 2, 5 and 7B, the toner introducing portion 13 constitutes the toner supply path 30 which guides the toner particles supplied from the toner supply portion 3 into the treatment chamber 10. The toner supply path 30 extends from the side face of the treatment tank 1 in the direction which is inclined in both the vertical and horizontal directions, and is connected to inside of the treatment chamber 10 via the toner supply port 130, which opens at the inner peripheral surface 102 of the treatment chamber 10. The toner supply path 30 extends in a direction along the tangential line of the inner peripheral surface 102 when viewed in the center axis line AX direction. In other words, the horizontal component of the flowing direction of the compressed air flow TF, supplied from the toner supply portion 3, is the direction parallel with the tangential line direction of the inner peripheral surface 102 of the treatment chamber 10, which is a cylindrical surface, in the view of the horizontal cross-section. Further, in the view in the diameter direction with respect to the center axis line AX, the toner supply path 30 extends downward as the location is closer to the toner supply port 130 in the peripheral direction of the inner peripheral surface 102. In other words, the flow direction of the air flow TF of the compressed air, supplied from the toner supply portion 3, is a direction inclined downward with respect to the horizontal direction.

The toner supply port 130 is disposed on the upper side of the inner peripheral surface 102 of the treatment chamber 10, and opens to an annular space AS between the outer peripheral surface 162 of the center pole 16 and the inner peripheral surface 102 of the treatment chamber 10. The edge portion of the toner supply port 130 has an approximately rhombus shape in the plan view of the inner peripheral surface 102.

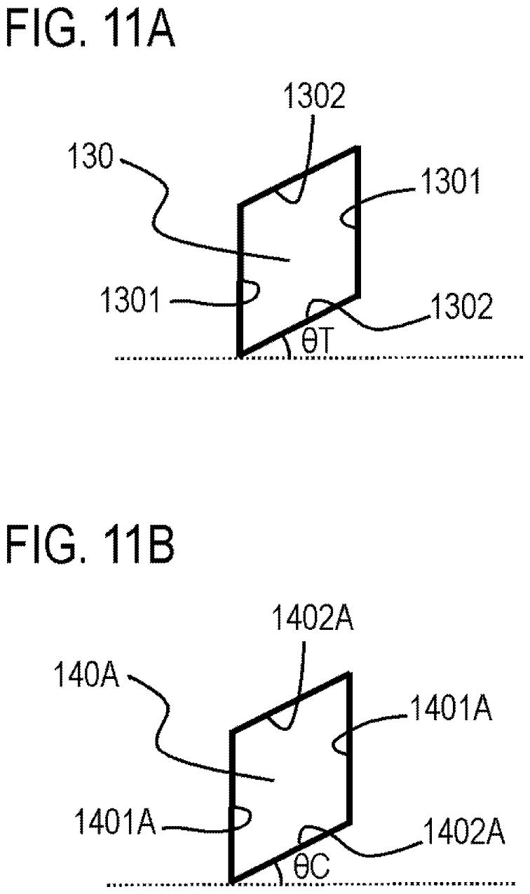

FIG. 11A is a schematic diagram depicting an opening shape of the toner supply port 130 in the plan view of the inner peripheral surface 102 of the treatment chamber 10. As illustrated in FIG. 11A, the edge portion of the toner supply port 130 is constituted of a pair of first edge portions 1301 which extend parallel with each other in the vertical direction, and a pair of second edge portions 1302 which extend parallel with each other in a direction inclined from the circumferential direction. In other words, the toner supply port 130 has an opening shape of a rhombus where the pair of first edge portions 1301 are the first opposing sides, and the pair of second edge portions 1302 are the second opposing sides. The pair of the second edge portions 1302 are inclined downward at angle θT)(°) from the horizontal direction.

The inclining directions of the toner supply path 30 and the toner supply port 130 are directions that are approximately along the direction of the air flow, which flows downward spirally turning through the annular space AS between the outer peripheral surface 162 of the center pole 16 and the inner peripheral surface 102 of the treatment chamber 10. In other words, the toner supply path 30 and the toner supply port 130 are configured to introduce toner particle into the treatment chamber 10 in a direction which does not impede the spiral flow of the hot air formed in the annular space AS by the hot air supply portion 2.

FIG. 7B is a cross-sectional view in the arrow BB direction in FIG. 3, and is a schematic cross-sectional view vertical to the center axis line AX in the treatment tank 1 at the position where the toner supply port 130 is disposed. In the view in the center axis line AX direction, the direction where the toner supply path 30 guides the toner particles is a direction that is approximately along the direction of the air flow, which flows downward spirally turning through the annular space AS.

In the configuration of Embodiment 1, when viewing downward from the top in the center axis line AX direction, air flow is generated to turn around the center axis line AX counterclockwise by a rectifying function of the louvers 164. The toner supply port 130 has the opening shape to introduce the toner particles into the annular space AS along this air flow which turns counterclockwise. In other words, the direction of the second edge portion 1302 of the toner supply port 130 inclining downward is approximately along the direction in which the air flow, generated in the annular space AS between the inner peripheral surface 102 and the outer peripheral surface of the center pole 16, spirally flows downward from the upper side of the annular space AS.

As illustrated in FIGS. 3, 5 and 7B, the treatment tank 1 according to Embodiment 1 includes four toner introducing portions 13, and the four toner supply ports 130 are open to the treatment chamber 10. The four toner introducing portions 13 are disposed in the peripheral direction of the inner peripheral surface 102 at equal intervals.

In the configuration of Embodiment 1, the toner supply port 130 is disposed at a plurality of locations so that the toner particles (treatment target thermoplastic particles) are dispersed and introduced from the plurality of locations. But the toner supply port 130 may be disposed only at one location so that toner particles are introduced from one location. In the case of disposing the toner supply port 130 at a plurality of locations, a number of locations is preferably 4 or 8.

First Cold Air Introducing Portion

As illustrated in FIGS. 2, 5 and 7C, the first cold air introducing portion 14A constitutes a first cold air supply path 40A which guides the cold air supplied from the cold air supply portion 4 into the treatment chamber 10. The first cold air supply path 40A extends from the side face of the treatment tank 1 in the direction which is inclined in both the vertical direction and the horizontal direction, and is connected to inside of the treatment chamber 10 via the first cold air supply port 140A, which opens on the inner peripheral surface 102 of the treatment chamber 10. The first cold air supply path 40A extends in a direction along the tangential line of the inner peripheral surface 102 when viewed in the center axis line AX direction. In other words, the horizontal component of the flowing direction of the cold air flow CF, supplied from the cold air supply portion 4, is a direction parallel with the tangential line direction of the inner peripheral surface 102 of the treatment chamber 10, in the view of the horizontal cross-section. Further, in the view in the diameter direction with respect to the center axis line AX, the first cold air supply path 40A extends downward as the location is closer to the first cold air supply port 140A in the peripheral direction of the inner peripheral surface 102. In other words, the flow direction of the air flow CF of the cold air supplied from the cold air supply portion 4 is a direction inclined downward with respect to the horizontal direction.

The first cold air supply port 140A is disposed below the toner supply port 130 on the inner peripheral surface 102, and opens to the annular space AS. The edge portion of the first cold air supply port 140A has an approximately rhombus shape in the plan view of the inner peripheral surface 102.

FIG. 11B is a schematic diagram depicting an opening shape of the first cold air supply port 140A in the plan view of the inner peripheral surface 102 of the treatment chamber 10. As illustrated in FIG. 11B, the edge portion of the first cold air supply port 140A is constituted of a pair of first edge portions 1401A which extend parallel with each other in the vertical direction, and a pair of second edge portions 1402A which extend parallel with each other in a direction inclined from the circumferential direction. In other words, the first cold air supply port 140A has an opening shape of a rhombus where the pair of first edge portions 1401A are the first opposing sides, and the pair of second edge portions 1402A are the second opposing sides. The pair of second edge portions 1402A are inclined downward at angle θC (°) from the horizontal direction.

The inclining directions of the first cold air supply path 40A and the first cold air supply port 140A are directions that are approximately along the direction of the air flow generated in the treatment chamber 10, spirally flowing downward inside of the treatment chamber 10. In other words, the first cold air supply path 40A and the first cold air supply port 140A are configured to introduce cold air into the treatment chamber 10, in a direction along the flow of the hot air flow inside of the treatment chamber 10 generated by the hot air supply portion 2. In the case of disposing the first cold air supply port 140A at a plurality of locations, a number of locations is preferably 4 or 8.

The treatment tank 1 according to Embodiment 1 includes four first cold air supply ports 140A, and the four first cold air supply ports 140A are open to the treatment chamber 10. The four first cold air supply ports 140A are disposed in the peripheral direction of the inner peripheral surface 102 at equal intervals.

Second Cold Air Introducing Portion

As illustrated in FIGS. 2, 5 and 7D, the second cold air introducing portion 14B constitutes a second cold air supply path 40B which guides the cold air, supplied from the cold air supply portion 4, into the treatment chamber 10. The second cold air supply path 40B extends from the side face of the treatment tank 1 in the horizontal direction, and is connected to inside of the treatment chamber 10 via the second cold air supply port 140B, which opens on the inner peripheral surface 102 of the treatment chamber 10. The second cold air supply path 40B extends in a direction along the tangential line of the inner peripheral surface 102 when viewed in the center axis line AX direction. In other words, the flowing direction of the cold air flow CF, supplied from the cold air supply portion 4, is a direction parallel with the tangential line direction of the inner peripheral surface 102 of the treatment chamber 10, in the view of the horizontal cross-section.

The second cold air supply port 140B is disposed below the first cold air supply port 140A on the inner peripheral surface 102, and opens to the annular space AS. The edge portion of the second cold air supply port 140B has a rectangular shape in the plan view of the inner peripheral surface 102. More specifically, the second cold air supply port 140B has an opening shape of a rectangle constituted of a pair of edge portions which extend parallel with each other in the vertical direction, and a pair of edge portions which extend parallel with each other in the circumferential direction.

The second cold air supply path 40B and the second cold air supply port 140B are disposed on the bottom surface 104 of the treatment chamber 10 in the peripheral direction around the center axis line AX, along the air flow inside of the treatment chamber 10, so that cold air is introduced into the treatment chamber 10.

The treatment tank 1 according to Embodiment 1 includes three second cold air supply ports 140B, and the three second cold air supply ports 140B open to the treatment chamber 10. These three second cold air supply ports 140B and the toner collection port 150 (described later) are disposed on the inner peripheral surface 102 in the peripheral direction at equal intervals.

In Embodiment 1, the second cold air supply port 140B is disposed at a height to contact the lower end of the inner peripheral surface 102, which is approximately the same height as the toner collection port 150. The height at which the second cold air supply port 140B is disposed is preferably the same height as the toner collection port 150, as in the case of Embodiment 1, in terms of guiding the toner particles smoothly into the toner collection port 150, but the second cold air supply port 140B may be disposed at a position higher than the toner collection port 150. In this case, the second cold air supply path 40B and the second cold air supply port 140B may be inclined in the same manner as the first cold air supply path 40A and the first cold air supply port 140A, in accordance with the height from the bottom surface 104 of the treatment chamber 10, for example.

In Embodiment 1, the cold air supply portion 4 supplies cold air in two steps using two cold air introducing portions (the first cold air introducing portion 14A and the second cold air introducing portion 14B). This configuration, however, is merely an example, and only one cold air introducing portion may be disposed, or three or more cold air introducing portions may be disposed.

In Embodiment 1, the first cold air supply port 140A and the second cold air supply port 140B are disposed at a plurality of locations respectively, so that the cold air is dispersed and introduced through a plurality of locations in the peripheral direction, but the first cold air supply port 140A and the second cold air supply port 140B may be disposed at one location respectively, so that the cold air is guided therefrom respectively.

Toner Discharging Portion

As illustrated in FIGS. 2, 5 and 7D, the toner discharging portion 15 constitutes a toner discharge path 50 to collect the thermally treated toner particles, from the treatment chamber 10 to the toner collection portion 5. The toner discharge path 50 extends from the side face of the treatment tank 1 in the horizontal direction, and is connected to inside of the treatment chamber 10 via the toner collection port 150, which opens on the inner peripheral surface 102 of the treatment chamber 10. The toner discharge path 50 extends in a direction along the tangential line of the inner peripheral surface 102 when viewed in the center axis line AX direction. The edge portion of the toner collection port 150 has a rectangular shape in the plan view of the inner peripheral surface 102, just like the second cold air supply port 140B.

In Embodiment 1, the toner collection port 150 is disposed only at one location, so that the thermally treated toner particles are collected at one location, but the toner collection port 150 may be disposed at a plurality of locations so that the toner particles are dispersed and collected at the plurality of locations.

Heat Sphering Treatment

As illustrated in FIG. 2, a space between the outer wall surface of the center pole 16 (upper end surface 161, outer peripheral surface 162, outer peripheral surface of cone 163, and louvers 164) and the inner wall surface of the treatment chamber 10 (top surface 101, inner peripheral surface 102, bottom surface 104) becomes a thermal treatment space to perform thermal treatment on toner particles. The air flow that flows through the thermal treatment space in the treatment chamber 10 is constituted of thermal treatment air flow using hot air, and cooling air flow generated by the hot air merging with the cold air. The thermal treatment air flow forms a thermal treatment zone HZ in the annular space AS between the inner peripheral surface 102 of the treatment chamber 10 and the outer peripheral surface 162 of the center pole 16. Further, the cooling air flow forms a cooling zone CZ below the thermal treatment zone HZ in the annular space AS.

As illustrated in FIG. 6, the hot air HA blown down from the hot air supply port 120 collides with the tip of the cone 163, and flows from the tip of the cone 163 toward the skirt (lower end), so as to disperse along the conical outer surface of the cone 163, and generates an air flow CDR which spreads approximately in a conical shape. The hot air HA released from the skirt of the cone 163 generates an air flow SHF, that spirally flows in the horizontal direction (direction vertical to the center axis line AX) toward the outer periphery side of the upper end surface 161 of the center pole 16, by the rectifying function of the louvers 164 disposed on the outer periphery of the cone 163. In other words, the hot air HA passes through a rectifying space that is formed among the plurality of louvers 164 so as to curve and extend spirally. At this time, the traveling direction of the hot air HA gradually changes from the direction toward the diameter direction to the direction along the counterclockwise direction around the center axis line AX, as the hot air HA travels closer to the outer diameter side in the diameter direction with respect to the center axis line AX.

The hot air HA, which flows through to the outer side of the upper end surface 161 of the center pole 16 while subject to the rectifying function by the louvers 164, moves toward the counterclockwise direction around the center axis line AX, and changes the traveling direction to the direction along the center axis line AX, so as to enter the annular space AS. In the annular space AS, an air flow SDF (thermal treatment air flow) that descends while spirally turning around the outer peripheral surface 162 of the center pole 16 is generated.

While descending turning around the outer peripheral surface 162 of the center pole 16, the thermal treatment air flow carries the toner particles, which were introduced from the toner supply port 130 along with compressed air, down to the cooling air flow on the downstream side. In the process of being carried by the thermal treatment air flow, the toner particles melt and change circularity thereof. For example, toner particles that initially had deformed shapes gradually become sphere-shaped, and transform such that circularity thereof enters a predetermined range. In this transforming process, the toner particles are exposed to the sphering force generated by the turning flow, hence the toner supplied to the treatment tank 1 disperses, and the coalescence of toner particles can be suppressed. Therefore a toner particles having a desired particle diameter and a circularity within a predetermined range can be obtained.

The thermal treatment zone HZ, where the toner particles are thermally treated by the thermal treatment air flow, is from the hot air supply port 120 to the upper end of the first cold air supply port 140A (to the height where the hot air merges with the cold air introduced from the first cold air supply port 140A) in the annular space AS.

When the hot air generated the thermal treatment air flow merges with the cold air introduced from the first cold air supply port 140A, and decreases the temperature, the air flow carrying the toner particles changes from the thermal treatment air flow to the cooling air flow. The cooling zone CZ, where toner particles are cooled by the cold air generating this cooling air flow, is generated from the first cold air supply port 140A to the bottom surface 104 of the treatment chamber 10 in the annular space AS. The cooling air flow is generated so as to descent while spirally turning around the outer peripheral surface 162 of the center pole 16, in the same manner as the thermal treatment air flow. The cooling air flow decreases the temperature of the thermally treated toner particles, and stabilizes the shapes of the toner particles. The cooling air flow, which reaches the lower end of the annular space AS, is suctioned into the toner collection port 150. The toner particles cooled by the cooling air flow are suctioned into the toner collection port 150, along with the cooling air flow suctioned into the toner collection port 150, and are collected in the toner collection portion 5.

Melt Adhesion of Toner Particles

In a heat sphering apparatus that carries toner particles from the supply port at the ceiling of the treatment chamber using air flow that descends spirally inside of the treatment chamber, and thermal treatment is performed on the toner particles, toner particles may melt and adhere to the wall surface inside of the treatment chamber, or toner particles may coalesce with each other. The generation of such melt adhesion and coalescence of toner particles influence the productivity to generate toner particles having a desired circularity, and the maintainability of the treatment apparatus.

The melt adhesion of toner particles to the inner wall surface of the treatment chamber may occur when the toner particles in the melt state contact the inner wall surface of the treatment chamber. The coalescence of toner particles, on the other hand, may occur when the toner particles remain in the melt state for a long time, whereby the chances of toner particles contacting with each other increases. The toner particles melt in the thermal treatment zone generated by the hot air, transform to toner particles having a desired circularity, and are then cooled in the cooling zone generated by the cold air, and are collected via the toner collection port. Here, in some cases, a part of the toner particles may return from the cooling zone to the thermal treatment zone, or may not exit the thermal treatment zone, due to the influence of the air flow generated in the treatment chamber, particularly due to the influence of the ascending air flow, and the toner particles may remain in the thermal treatment zone for a long time. If such remaining of the toner particles in the thermal treatment zone for a long time occurs, the chances for melted toner particles to contact the inner wall surface of the treatment chamber increase, and the chances for melted toner particles to contact with each other increase as well.

According to the research by the inventor of the present invention, in the treatment tank in which thermal treatment is performed on the toner particles by generating air flow that spirally turns around the center pole downward from the upper portion of the treatment chamber, melt adhesion of toner particles tends to be generated particularly in the upper region of the treatment chamber. In the treatment tank in this configuration, toner particles tends to remain and the melt adhesion of toner particles tends to occur in the upper end area of the center pole, and in the upper end side of the inner peripheral surface of the treatment chamber, particularly in the upper end area of the toner supply port. The inventor of the present invention discovered that the remaining of toner particles in the upper region of the treatment chamber is caused by the ascending air flow generated in the annular space of the treatment chamber. This ascending air flow may be generated because of the separation of air flow in the annular space of the treatment chamber. In other words, on the inner side (inner periphery side of the annular space) of the spirally descending air flow, which spirally turns downward from the upper part of the treatment chamber, the ascending air flow moving upward from the lower part of the treatment chamber along the outer shape of the center pole is generated separately from the spirally descending air flow.

Inclined Surface

As a configuration to suppress the above mentioned melt adhesion of toner particles, the treatment tank 1 of Embodiment 1 includes the inclined surface 103 between the top surface 101 and the inner peripheral surface 102, and this inclined surface 103 is inclined from the top surface 101 and from the inner peripheral surface 102 respectively. The present inventor discovered in the research that the generation of ascending air flow in the air flow generated in the annular space AS can be suppressed by the effect of this inclined surface 103.

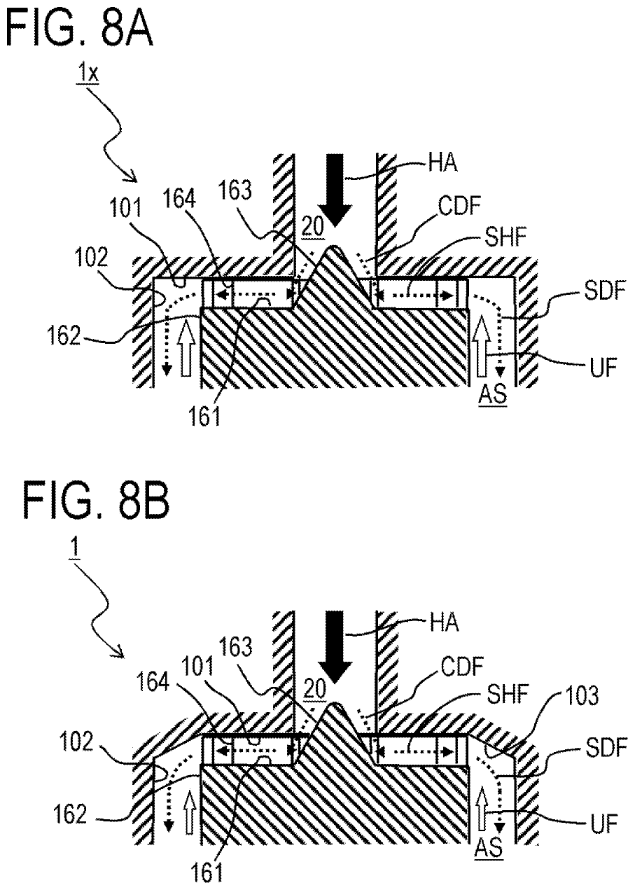

FIG. 8A is a schematic cross-sectional view of an upper region of the treatment chamber 10 in a treatment tank 1x according to Comparative Embodiment 1, where the inclined surface 103 is not disposed. FIG. 8B is a schematic cross-sectional view of the upper region of the treatment chamber 10 in the treatment tank 1 according to Embodiment 1, where the inclined surface 103 is disposed.

As illustrated in FIG. 8A, on the upper end side of the annular space AS, the hot air supplied from the hot air supply port 120 descends along the conical surface of the cone 163, and changes the direction to the horizontal direction in which the hot air spirally turns toward the outer diameter side, by the rectifying function of the louvers 164. Then the hot air which exited the louvers 164 changes direction downward in the vertical direction, and spirally turns and descends in the annular space AS.

In the treatment tank 1x of the Comparative Embodiment 1, the melt adhesion of toner particles is clearly generated around the toner supply port 130 on the inner peripheral surface 102 of the treatment chamber 10, and around the outlet of the spiral passage divided by the louvers 164 of the center pole 16. In other words, these regions are where toner particles easily remain and easily melt-adhere in the treatment tank 1x. The remaining of toner particles in the upper region of the treatment chamber 10 is caused by the ascending air flow UF generated in the annular space AS, and this ascending air flow UF may be generated because of the separation of air flow in the annular space AS. Specifically, on the inner side (inner periphery side of the annular space AS) of the spirally descending air flow SDF, which spirally turns downward from the upper part of the treatment chamber 10, the ascending air flow UF, that moves upward from the lower part of the treatment chamber along the outer shape of the center pole, is generated separately from the spirally descending air flow SDF.

The hot air supplied from the hot air supply port 120 may rebound off the upper end surface 161 of the center pole 16, generate an apex flow in the louvers 164, and reach an area close to the toner supply port 130. The hot air that generated this apex flow merges with the ascending air flow UF generated around the outer peripheral surface 162 of the center pole 16, and pulls the toner introduced from the toner supply port 130 into the ascending air flow UF. The toner particles pulled into the ascending air flow UF move above the toner supply port 130, and remain around the toner supply port 130 and around the outlet of the spiral passage generated by the louvers 164.

Further, in Comparative Embodiment 1, the inner peripheral surface 102 of the treatment chamber 10 is disposed to face the outlet of the rectifying path of the louvers 164. Thereby the spirally horizontal air flow SHF of the hot air HA that exited the louvers 164 continuously moves in the horizontal direction, and collides with the inner peripheral surface 102 of the treatment chamber 10. By this collision, a loss is generated in the flow of the spirally horizontal air flow SHF, and as a result, the flow of the spirally descending air flow SDF is weakened, and the ascending air flow UF, which is separated from the spirally descending air flow SDF, is more easily generated in the annular space AS.

In the treatment tank 1 of Embodiment 1, a tapered inclined surface 103, which is formed between the top surface 101 and the inner peripheral surface 102 of the treatment chamber 10, is disposed to face the outlet of the rectifying path of the louvers 164. A downward component in the vertical direction, in accordance with the angle of the inclined surface 103, is added to the spirally horizontal air flow SHF of the hot air HA, which exited the louvers 164 and collided with the inclined surface 103. Thereby the flow of the hot air HA is drawn from the spirally horizontal air flow SHF to the spirally descending air flow SDF. Hence, a loss of the air flow caused by the air flow colliding with the inner wall surface of the treatment chamber 10 is reduced, and the direction of the flow of the hot air HA is changed from the spirally horizontal air flow SHF to the spirally descending air flow SDF, with less loss. As a result, the spirally descending air flow SDF having sufficient strength is generated in the annular space AS, generation of the ascending air flow UF in the annular space AS is suppressed, and the melt adhesion of toner particles is suppressed.

According to the knowledge acquired by the research of the present inventor, it is preferable that the cross-section of the inclined surface 103 is a flat surface that extends linearly. According to the analysis of air flow in the treatment chamber 10 performed by the present inventor, in the case of the treatment chamber 10, where the top surface 101 and the inner peripheral surface 102 are connected at a right angle, as in the case of Comparative Embodiment 1, a ring-shaped ascending air flow is generated at the upper corners of the treatment chamber 10. Specifically, the ring-shaped ascending air flow is clearly generated at the corners between the top surface 101 and the inner peripheral surface 102, and around the upper end (near the boundary with the upper end surface 161) of the outer peripheral surface 162 of the center pole 16. Further, according to the knowledge acquired by research of the present inventor, the above mentioned effect of suppressing the ascending air flow cannot be sufficiently acquired in the configuration of connecting the top surface 101 and the inner peripheral surface 102 via a recessed R-shaped curved surface (Comparative Embodiment 2), for example.

The differences of the configuration between Embodiment 1 and Comparative Embodiments 1 and 2 are as follows, for example. In Comparative Embodiments 1 and 2, the configuration of the inner wall surface (top surface 101 and the inner peripheral surface 102) of the treatment chamber 10, which faces the upper edge corner (the boundary between the upper end surface 161 and the outer peripheral surface 162 of the center pole 16), is recessed in a direction distant from the corner portion of the center pole 16. In Embodiment 1, on the other hand, the position where the corner portion of the center pole 16 and the inner wall surface of the treatment chamber 10 are closest is located on the inclined surface 103. In other words, in Embodiment 1, the passage area of the air flow that passes the upper end corner portion of the center pole 16 is decreased on the inclined surface 103.

Particularly in the configuration of Comparative Embodiment 1, in the inner wall surface of the treatment chamber 10, the top surface 101 or the inner peripheral surface 102 takes the position where the inner wall surface of the treatment chamber 10 is closest to the upper end corner portion of the center pole 16. In other words, the corner portion between the top surface 101 and the inner peripheral surface 102 is recessed in a direction distant from the upper end corner portion of the center pole 16, and air flow tends to remain (air flow stagnation) in such a recessed portion. In the case of the configuration of Comparative Embodiment 2 as well, the generation of air flow stagnation is not sufficiently suppressed unlike the case of Embodiment 1, even if a somewhat better than Comparative Embodiment 1.

As described above, according to the configuration of Embodiment 1, the generation of the ascending air flow UF in the annular space AS can be effectively suppressed, and the melt adhesion of toner particles can be suppressed.

Dimensional Relationship of Treatment Tank of Embodiment 1

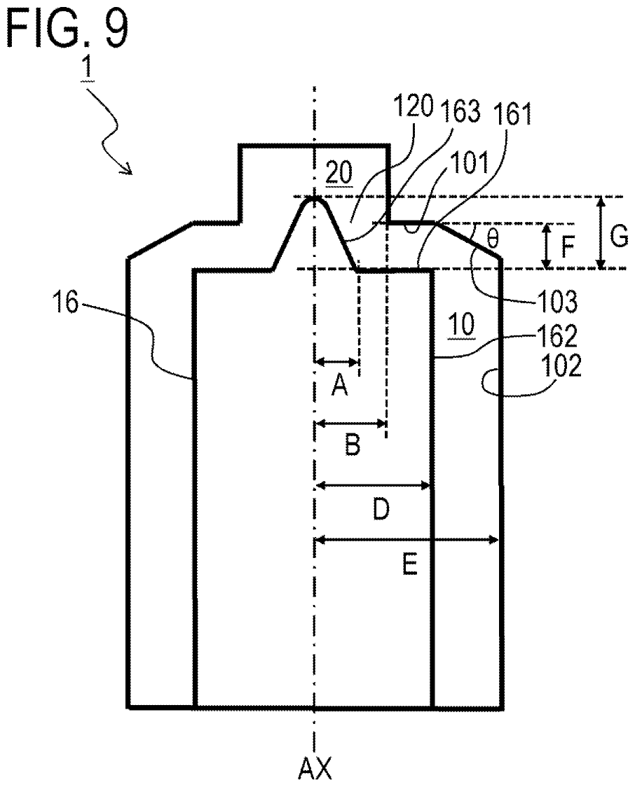

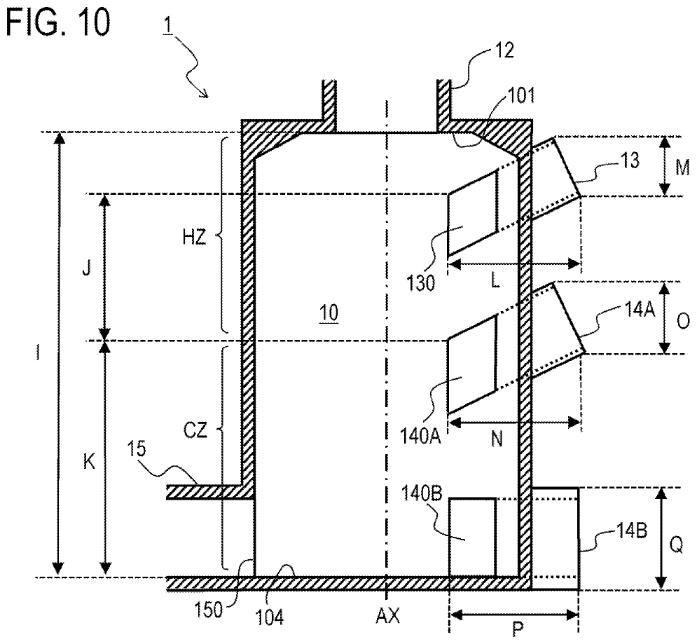

FIG. 9 is a schematic diagram indicating the dimensions of each composing element of the treatment tank 1 according to Embodiment 1. FIG. 10 is a schematic cross-sectional view of the treatment tank 1 for describing the dimensions of each composing element of the treatment tank 1. Although there are a plurality of toner introducing portions 13, first cold air introducing portions 14A and second cold air introducing portion 14B, only one representative portion is illustrated in FIG. 10 respectively. FIG. 11A is a schematic diagram of the toner supply port 130 in the two-dimensionally expanded view of the inner peripheral surface 102 of the treatment chamber 10. FIG. 11B is a schematic diagram of the first cold air supply port 140A in the two-dimensionally expanded view of the inner peripheral surface 102 of the treatment chamber 10.

In FIG. 9, A indicates the lower end surface of the cone 163. B indicates the radius of the hot air supply port 120. D indicates the diameter of the outer peripheral surface 162 of the center pole 16, and is the outer diameter of the upper end surface 161. E indicates the diameter of the inner peripheral surface 102 of the treatment chamber 10. F indicates the height from the upper end surface 161 of the center pole 16 to the top surface 101 of the treatment chamber 10. And G indicates the height of the tip of the cone 163 from the upper end surface 161 of the center pole 16.

Table 1 indicates the estimated dimensional ranges of various dimensions indicated in FIG. 9, and the preferred ranges thereof.

TABLE 1

| | Estimated range (mm) | Preferred range (mm) |
|---|---|---|
| A | 12 to 55 | 24 to 43 |
| B | 15 to 70 | 30 to 58 |
| D | 12 to 180 | 55 to 165 |
| E | 60 to 250 | 75 to 225 |
| F | 5 to 50 | 10 to 35 |
| G | 5 to 80 | 35 to 65 |

In FIG. 10, I indicates the height from the bottom surface 104 to the top surface 101 of the treatment chamber 10. J indicates the range of the thermal treatment zone HZ formed in the treatment chamber 10 in the vertical direction, and is the vertical width from the lowest position at the upper end of the toner supply port 130 to the lowest position at the upper end of the first cold air supply port 140A. K indicates the range of the cooling zone CZ formed in the treatment chamber 10 in the vertical direction, and is the vertical width from the lowest position at the upper end of the first cold air supply port 140A to the bottom surface 104 of the treatment chamber 10. L indicates the width of the toner introducing portion 13 in the horizontal direction. M indicates the width of the upstream side opening of the toner introducing portion 13 in the vertical direction. N indicates the width of the first cold air introducing portion 14A in the horizontal direction. O indicates the width of the upstream side opening of the first cold air introducing portion 14A in the vertical direction. P indicates the width of the second cold air introducing portion 14B in the horizontal direction. And Q indicates the width of the upstream side opening of the second cold air introducing portion 14B in the vertical direction.

Table 2 indicates the estimated dimensional ranges of various dimensions indicated in FIG. 10, and the preferred ranges thereof.

TABLE 2

| | Estimated range (mm) | Preferred range (mm) |
|---|---|---|
| I | 100 to 450 | 145 to 350 |
| J | 150 to 900 | 200 to 750 |
| K | 300 to 1500 | 400 to 1100 |
| L | 50 to 200 | 80 to 160 |
| M | 50 to 100 | 65 to 90 |
| N | 70 to 300 | 100 to 250 |
| O | 70 to 180 | 100 to 140 |
| P | 100 to 400 | 160 to 350 |
| Q | 50 to 150 | 70 to 100 |

In the above mentioned ranges, the diameter of the circle, which is the boundary line between the top surface 101 and the inclined surface 103, is set to be the same diameter as the diameter of the outer peripheral surface 162 of the center pole 16. The height of the toner supply port 130 is set to be lower than the position of the upper end surface 161 of the center pole 16. Each of the above dimensions are set such that the width (D-A) of the louver 164 in the diameter direction, with respect to the center axis line AX, can be 15 mm to 150 mm as the estimated range, and 28 mm to 111 mm as the preferred range.

In the configuration of Embodiment 1, 12 louvers 164 are disposed around the cone 163 at equal intervals of 30°.

The basic operation conditions in the sphering treatment of the heat sphering apparatus X of Embodiment 1 are set as follows, for example.
Supply amount of toner particles (treatment amount, feed amount): 5 kg/hr
Hot air temperature: 160° C.
Hot air quantity: 7.0 m³/min
Cold air temperature: −5° C.
Cold air in first step (introduced by 4 divisions): 0.5 m³/min
Cold air in second step (introduced by 3 divisions): 0.5 m³/min
Compressed air quantity: 0.4 m³/min supplied by 4 divisions
Blower air quantity: 15.0 m³/min

### Comparison Experiment 1

Here the reduction ratios of the ascending air flow components, when the difference between the outer peripheral diameter and the inner peripheral diameter of the inclined surface 103 is 60 mm, and the angles γ that the inclined surface 103 forms with the top surface 101 are 17°, 27° and 40°, are −1.1%, −3.6% and −1.1% respectively. Then a comparison experiment was performed for the average particle diameter and the average circularity of the toner particles, between Example 1, where the angle γ of the inclined surface 103 is 27°, and Comparative Example 1 which does not include the inclined surface 103. In this comparison experiment, the supply amount (treatment amount) of the toner particles is 10.3 kg/hr.

Measurement Method of Weight-Average Particle Diameter (D4)

The weight-average particle diameter (D4) of toner is calculated as follows. For the measurement device, a precision particle size distribution measurement device, the “Coulter Counter Multisizer 3” (registered trademark, made by Beckman Coulter, Inc.) based on a pore electrical resistance method, including a 100 μm aperture tube, is used. For the settings of the measurement conditions and analysis of the measured data, dedicated software “Beckman Coulter Multisizer 3 ver. 3.51” (made by Backman Coulter Inc.), provided with the measurement device, is used. Measurement is performed using 25,000 effective measurement channels.

For the aqueous electrolytic solution used for measurement, a solution prepared by dissolving high grade natrium chloride in deionized water so that the concentration becomes about 1% by mass, “ISOTON II” (made by Beckman Coulter, Inc.), for example, can be used.

Before performing the measurement and analysis, the dedicated software was set as follows. On the screen “Change standard measurement method (SOM)” of the dedicated software, the total count of particles of the control mode is set to 50,000, the number of times of measurement is set to 1, and the Kd value is set to a value acquired using the “standard particles 10.0 μm” (made by Beckman Coulter, Inc.). The threshold and noise level are automatically set by pressing the “threshold/noise level measurement button”. Further, the current is set to 1600 μA, the gain is set to 2, the electrolytic solution is set to ISOTON II, and the “flash aperture tube after measurement” is checked. On the “Pulse to particle diameter conversion setting” screen of the dedicated software, the bin interval is set to a logarithmic particle diameter, the particle diameter bin is set to 256 particle diameter bin, and the particle diameter range is set to 2 μm to 60 μm.

Specific measurement method is as follows.

(1) Pour 200 mL of the aqueous electrolytic solution into a 250 mL round bottom glass beaker dedicated to Multisizer 3, set it in a sample stand, and stir with the stir rod counterclockwise at 24 revolutions/second. Then remove contamination and bubbles inside of the aperture tube in advance using the “Aperture flush” function of the dedicated software.

(2) Pour 30 mL of the aqueous electrolytic solution into a 100 mL flat bottom glass beaker. In this solution, add about 0.3 mL of diluted solution, as the dispersing agent, which is prepared by diluting “Contaminon N” 10% by mass solution of pH7 neutral detergent for cleaning precision measuring instruments constituted of: nonionic surfactant, anionic surfactant and organic builder, made by Wako Pure Chemical Industries, Ltd.) to about 3 times the mass with deionized water.

(3) Prepare the ultrasonic dispersion device “Ultrasonic Dispension System Tetora 150” (made by Nikkaki Bios Co., Ltd.) having a 120 W electric output, in which two oscillators, each having a 50 kHz oscillation frequency, are included in a 180° phase shifted state. Pour about 3.3 l of deionized water into a water tank of the ultrasonic dispersion device, and add about 2 ml of Contaminon N into this water tank.

(4) Set the above beaker described in (2) onto the beaker fixing hole of the above mentioned ultrasonic dispersion device, and activate the ultrasonic dispersion device. Then the height position of the beaker is adjusted so that the resonating state of the liquid surface of the aqueous electrolytic solution inside of the beaker reaches the maximum.

(5) Gradually add about 10 mg of toner to the aqueous electrolytic solution in a state where ultrasonic waves are emitted to the aqueous electrolytic solution in the beaker described in (4), and disperse the toner therein. The ultrasonic dispersion processing continues for 60 more seconds. In the ultrasonic dispersion, the water temperature of the water tank is appropriately adjusted to be at least 10° C. and not more than 40° C.

(6) Using a pipette, drip the toner-dispersed aqueous electrolytic solution described in (5) into the round bottom beaker described in (1) that is set in the sample stand, and adjust such that the measurement concentration becomes about 5%. Continue measurement until the number of measured particles becomes 50,000.

(7) Analyze the measured data using the dedicated software provided with the measurement device, and calculate the weight-average particle diameter (D4). The weight-average particle diameter (D4) is an “average diameter” on the “analysis/volume statistic values (arithmetic mean)” when the graph/volume % is set in the dedicated software.

Measurement Method of Average Circularity

The average circularity of toner particles is measured under the measurement and analysis conditions used for calibration by the flow type particle image analyzer “FPIA-3000” (made by Sysmex Corp.).

The specific measurement method is as follows. First pour about 20 mL of deionized water, from which solid impurities and the like have been removed, into a glass container. To this solution, add about a 0.2 mL diluted solution, as the dispersing agent, which is prepared by diluting “Contaminon N” (10% by mass solution of pH7 neutral detergent for cleaning precision measurement instruments constituted of: nonionic surfactant, anionic surfactant and organic builder, made by Wako Pure Chemical Industries, Ltd) to about 3 times mass with deionized water. Furthermore, add about 0.02 g of the measurement sample thereto, and dispersion processing is performed for 2 minutes using an ultrasonic dispersion device, so as to prepare the dispersion solution for measurement. Here, use the dispersion solution that is appropriately cooled so that the temperature thereof becomes at least 10° C. and not more than 40° C. Using a desk top type ultrasonic cleaning dispersion device (“VS-150” (made by Velvo-Clear Co.)), of which oscillation frequency is 50 kHz and electric output is 150 W, as the ultrasonic dispersion device, pour a predetermined amount of deionized water into the water tank, and add about 2 mL of the above mentioned Contaminon N.

For measurement, the above mentioned flow type particle image analysis device, including standard objective lenses (×10), is used, and the particle sheath “PSE-900A” (made by Sysmex Corp.) is used for the sheath liquid. The dispersion solution prepared according to the above mentioned procedure is introduced into the flow type particle image analysis device, and 3000 toner particles are measured in the HPF measurement mode and total count mode. Then the binarization threshold during the particle analysis is set to 85%, and the analysis particle diameter is limited to an equivalent circle diameter of at least 1.985 μm and less than 39.69 μm, whereby the average circularity of the toner particles is determined.

Before measurement, automatic focus adjustment is performed using standard latex particles (“Research and Test Particles: Latex Microsphere Suspensions 5200A” made by Duke Scientific Co., diluted with deionized water). It is preferable to adjust focus every 2 hours after the start of measurement.

In this example of the present application, a flow type particle image analysis device having calibration certification issued by Sysmex Corp., which certifies that Sysmex Corp. performed the calibration, was used. Except for the analysis particle diameter being limited to an equivalent circle diameter of at least 1.985 μm and less than 39.69 μm, the measurement and analysis conditions which were set when the calibration certification was issued were used for measurement.

TABLE 3
Relationship of toner average particle
diameter and treatment temperature

| Temperature (° C.) | 160 | 180 | 190 | 200 | 210 |
|---|---|---|---|---|---|
| Comparative Example 1 | 5.56 | 5.6 | 5.82 | 6.02 | 6.52 |
| Toner average particle | | | | | |
| diameter (μm) | | | | | |
| Example 1 | 5.59 | 5.72 | 5.65 | 5.91 | 6.19 |
| Toner average particle | | | | | |
| diameter (μm) | | | | | |

TABLE 4
Relationship of average circularity of toner particles and treatment

| Temperature (° C.) | 160 | 180 | 190 | 200 | 210 |
|---|---|---|---|---|---|
| Comparative Example 1 | 0.961 | 0.963 | 0.963 | 0.959 | 0.955 |
| Average circularity | | | | | |
| Example 1 | 0.961 | 0.963 | 0.964 | 0.962 | 0.959 |
| Average circularity | | | | | |

As Tables 3 and 4 indicate, in Comparative Example 1, the changes of the toner average particle diameter and circularity become more conspicuous as the treatment temperature increases. In Embodiment 1, however, such changes are suppressed, and the melt adhesion of toner particles is reduced compared with Comparative Example 1. In other words, according to Embodiment 1, the dispersion of the toner average particle diameter and circularity of toner particles, depending on the treatment temperature, can be suppressed.

According to the knowledge of the present inventor, the practical setting range of the angle θ(°) of the inclined surface 103 formed with the top surface 101 on the vertical cross-section, when the dimensional ranges indicated in FIGS. 10, 11A and 11B are used, is 10<θ≤45. The lower limit value 10° and the upper limit value 45° are values that the present inventor acquired via research, as the critical values with which the effect of the inclined surface 103 can be expected. In this range, the inclination angle of the inclined surface 103 is appropriately set in accordance with the dimensions of other devices.

Further, in Embodiment 1, the flow direction of the air flow TF of the compressed air, which enters into the treatment chamber 10 by the toner supply portion 3 and the toner introducing portion 13, has an angle θT)(°) which is an angle downward from the horizontal direction. In Embodiment 1, the angle θT is set to satisfy θT≤θ, where θ(°) is an angle which the inclined surface 103 forms with the top surface 101.

### Embodiment 2

A treatment tank 1b according to Embodiment 2 of the present invention will be described. Here only aspects of Embodiment 2 that are different from Embodiment 1 will be described. Aspects that are not especially described in Embodiment 2 are the same as Embodiment 1.

Compared with the treatment tank 1 of Embodiment 1, the treatment tank 1b of Embodiment 2 is configured such that an R shape, which has a radius of curvature in a predetermined range, is added to the tip (apex) of the cone 163, and an R shape, which has a radius of curvature in a predetermined range, is also added to the outer periphery (corner) of the upper end of the center pole 16. By adding these predetermined R shapes, the generation of the ascending air flow components in the air flow of the treatment chamber 10 can be effectively suppressed. Furthermore, if the configuration of the treatment tank 1b includes the inclined surface 103, the generation of the ascending air flow components can be suppressed even more effectively, due to the synergistic effect.

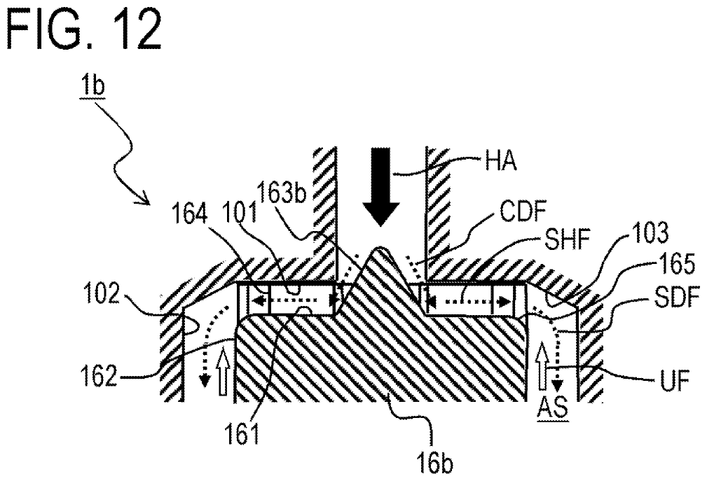

FIG. 12 is a schematic cross-sectional view of an upper region of the treatment chamber 10 in the treatment tank 1b of Embodiment 2. According to the configuration of the treatment tank 1b of Embodiment 2, the predetermined R shape added to the tip of the cone 163 changes of the flow of the hot air HA to be smooth, from the hot air HA colliding with the tip of the cone 163 to forming the conically dispersed air flow CDF along the outer surface of the cone 163. Further, the predetermined R shape added to the outer periphery (corner) of the upper end of the center pole 16 smoothly changes the direction of the flow of the hot air HA after exiting the louvers 164, from the spirally horizontal air flow SHF to the spirally descending air flow SDF. Thereby the generation of the ascending air flow UF in the annular space AS can be suppressed, the remaining of the toner particles in an upper portion of the treatment chamber 10 is suppressed, and the melt adhesion of toner particles is suppressed.

Dimensional Relationship of Treatment Tank of Embodiment 2

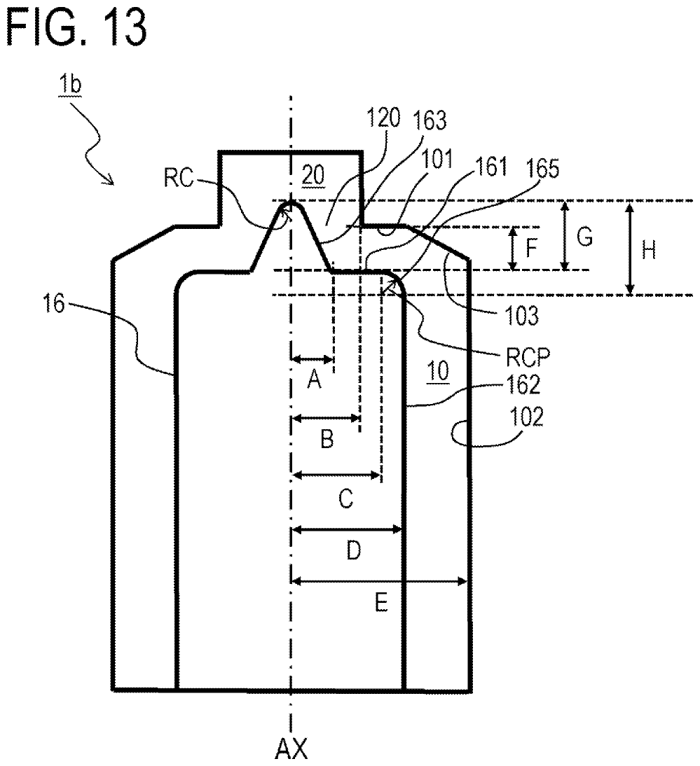

FIG. 13 is a schematic diagram indicating the dimensions of each composing element of the treatment tank 1b according to Embodiment 2. In Embodiment 2, each dimensional setting range, A, B, D, E, F and G, is the same as Embodiment 1. In Embodiment 2, C is an outer diameter of the upper end surface 161 of the center pole 16, and is a diameter from the center axis line AX to the boundary between the upper end surface 161 and the R-shaped portion 165. H is a difference in the vertical direction of the position of the tip of the cone 163 of the center pole 16 and the position of the boundary between the R-shaped portion 165 of the center pole 16 and the outer peripheral surface 162. Table 5 indicates the estimated dimensional ranges indicated in FIG. 13, and the preferred ranges of various dimensions thereof.

TABLE 5

| | Estimated range (mm) | Preferred range (mm) |
|---|---|---|
| A | 12 to 55 | 24 to 43 |
| B | 15 to 70 | 30 to 58 |
| C | 12 to 170 | 45 to 140 |
| D | 12 to 180 | 55 to 165 |
| E | 60 to 250 | 75 to 225 |
| F | 5 to 50 | 10 to 35 |
| G | 5 to 80 | 35 to 65 |
| H | 30 to 130 | 40 to 100 |

### Comparison Experiment 2

Concerning the effect of adding the R shape to the tip (apex) of the cone 163, a comparison experiment is performed between Example 2, where the R shape with a 10 mm radius of curvature was added to the tip of the cone 163, and Comparative Example 2, where no R shape was added to the tip of the cone 163. In this comparison experiment, the supply amount (treatment amount) of toner particles is 8.0 kg/hr, and the hot air quantity is 8.0 m 3/min.

TABLE 6
Relationship of toner average particle diameter
and treatment temperature

| Temperature (° C.) | 170 | 180 | 190 |
|---|---|---|---|
| Comparative Example 2 | 5.35 | 5.53 | 5.84 |
| Toner average particle | | | |
| diameter (μm) | | | |
| Example 2 | 5.22 | 5.43 | 5.66 |
| Toner average particle | | | |
| diameter (μm) | | | |

TABLE 7
Relationship of average circularity of toner
particles and treatment

| Temperature (° C.) | 170 | 180 | 190 |
|---|---|---|---|
| Comparative Example 2 | 0.962 | 0.965 | 0.964 |
| Average circularity | | | |
| Example 2 | 0.962 | 0.964 | 0.964 |
| Average circularity | | | |

As Tables 6 and 7 indicate, according to Embodiment 2, the change of circularity caused by the change of treatment temperature decreases (circularity is stabilized), and the change of toner average particle diameter is also decreased. As a result, the melt adhesion of toner particles can be decreased compared with Comparative Example 2.

According to the knowledge of the present inventor, the practical setting range of the radius of curvature R (mm) of the R shape added to the tip (apex) of the cone 163, when the dimensional ranges indicated in FIGS. 10, 11A, 11B and 13 are used, is 0<R≤85, and is preferably 5<R<45.

Comparison Experiment 3

Concerning the effect of adding the R shape to the outer periphery (corner) of the upper end of the center pole 16, a comparison experiment was performed. In this comparison experiment, Example 3, where a 7 mm R shape is added to the outer periphery of the upper end of the center pole 16, Example 4 where an 18 mm R shape is added to the outer periphery of the upper end of the center pole 16, and Comparative Example 3, where no R shape is added to the outer periphery of the upper end of the center pole 16 were compared. In this comparison experiment, the average circularity of the treated toner particles was measured in Example 3, Example 4 and in Comparative Example 3 respectively at treatment temperature 180° C.

TABLE 8

| | Average circularity |
|---|---|
| Comparative Example 3 | 0.963 |
| Example 3 | 0.964 |
| Example 4 | 0.966 |

As Table 8 indicates, according to the result of this experiment, the circularity improves as the radius of curvature of the R shape added to the outer periphery of the upper end of the center pole 16 is larger.

Comparison Experiment 4

Concerning the effect of the combination of the R shape at the tip (apex) of the cone 163, the R shape at the outer periphery (corner) of the upper end of the center pole 16, and the inclined surface 103 according to Embodiment 2, a comparison experiment was performed. In this comparison experiment, a configuration where an R shape is added to the outer periphery of the upper end of the center pole 16, without disposing the inclined surface 103 at the upper corner of the treatment chamber 10, was used as Comparative Embodiment 4. In the configuration of Embodiment 2, the angle γ of the inclined surface 103 is 27°, and the R shape having a 10 mm radius of curvature is added to the tip of the cone 163. In each of Embodiment 2 and Comparative Embodiment 4, the radius of curvature RCP of the R shape added to the outer periphery of the upper end of the center pole 16 was set to 18, 27, 45, 60, 70, 80, 100 and 120 mm, and the ascending air flow component in the treatment chamber 10 was acquired respectively by the SIM analysis. Then for each of Embodiment 2 and Comparative Embodiment 4, the reduction ratio of the ascending air flow component at each radius of curvature RCP was acquired, with respect to the Comparative Embodiment 1 where the inclined surface 103 is not disposed in the treatment chamber 10, and the R shape is not added to the center pole 16 and the cone 163. Table 9 indicates the result.

TABLE 9

| | RCP [mm] | | | | | | | |
|---|---|---|---|---|---|---|---|---|
| | 18 | 27 | 45 | 60 | 70 | 80 | 100 | 120 |
| Comparative | −13.1% | −34.5% | −46.1% | −36.9% | −38.3% | −43.9% | −52.7% | −56.3% |
| Embodiment 4 | | | | | | | | |
| Embodiment 2 | −30.4% | −42.8% | −41.5% | −44.2% | −51.4% | −50.1% | −52.7% | −56.1% |

In Comparative Embodiment 4, an effect of suppressing the ascending air flow similar to Embodiment 2 is acquired in the range where R is 100 mm or more, but the effect of suppressing the ascending air flow conspicuously drops in the range where R is smaller than 45 mm, and the effect disperses in the range where R is 45 mm to 80 mm. In Embodiment 2, on the other hand, the effect of suppressing the ascending air flow can be acquired in the range wider than Comparative Embodiment 4.

According to the knowledge of the present inventor, the practical setting range of the radius of the curvature of the R shape added to the outer periphery (corner) of the upper end of the center pole 16, when the dimensional ranges indicated in FIGS. 10, 11A, 11B and 13 are used, is 5<RCP<75 in Embodiment 2.

### Embodiment 3

A treatment tank 1c according to Embodiment 3 of the present invention will be described. Here only aspects of Embodiment 3 that are different from Embodiments 1 and 2 will be described. Aspects that are not especially described in Embodiment 3 are the same as Embodiments 1 and 2.

In Embodiment 3, the top surface of the treatment chamber 10 is a tapered inclined surface 103c, unlike the top surfaces 101 of Embodiments 1 and 2, which are horizontal surfaces. Further, in the configuration of Embodiment 3, a protruded portion 163c, which conically protrudes from the boundary with the outer peripheral surface 162, is disposed at the tip (upper end) of the center pole 16c, instead of disposing the horizontal surface, such as the upper end surface 161 of Embodiments 1 and 2. The louvers 164c, to generate the spirally turning flow are disposed on the conical outer peripheral surface of the protruded portion 163c. At the tip (apex) of the protruded portion 163c, the R shape is added just like the case of the tip of the cone 163 in Embodiment 2.

When the hot air that blows downward from the hot air supply port 120 collides with the tip of the protruded portion 163c, the hot air disperses and moves down along the conical outer peripheral surface of the protruded portion 163c, and moves vertically downward along the outer peripheral surface of the protruded portion 163c while spirally turning by the rectifying function of the louvers 164c. The hot air that exited the louvers 164c descends in the annular space AS between the inner peripheral surface 102 of the treatment chamber 10 and the outer peripheral surface 162 of the center pole 16, while spirally turning around the outer peripheral surface 162 of the center pole 16.

In the configurations of Embodiments 1 and 2, the inclined surface 103, which is inclined downward in the direction toward the outer peripheral portion of the treatment chamber 10, exists in part on the outer periphery of the hot air supply port 120 when the treatment chamber 10 is viewed in the center axis line AX direction. According to Embodiment 3, on the other hand, the inclined surface 103c exists throughout the outer peripheral of the hot air supply port 120 of the treatment chamber 10 when the treatment chamber 10 is viewed in the center axis line AX direction. According to Embodiment 3, no wall to control the air flow, to move in the horizontal direction, exists between the hot air supply port 120 and the annular space AS, and the air flow from the hot air supply path 20 to the annular space AS can flow smoothly. Therefore the generation of the ascending air flow in the annular space AS can be suppressed effectively.

Each of the above embodiments and examples may be combined if possible.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2022-162449, filed on Oct. 7, 2022, and No. 2023-159157, filed on Sep. 22, 2023, which are hereby incorporated by reference herein in their entirety.

What is claimed is:

1. A thermal treatment apparatus comprising:
a treatment tank including a treatment chamber to perform thermal treatment on toner particles;
a toner particle supply unit configured to supply toner particles into the treatment chamber; and
a hot air supply unit including a supply port to supply hot air into the treatment chamber, wherein
the supply port of the hot air supply unit is disposed on a ceiling of the treatment chamber, wherein
the treatment tank further including:
a columnar member that is vertically disposed at the center inside of the treatment chamber; and
a protruded member that is disposed at an upper end of the columnar member and has an approximately conical shape protruding toward the ceiling, wherein
the columnar member has a cylindrical shape and a radius of curvature RCP (mm) of an upper end edge in a vertical cross-section thereof is 5<RCP<75.

2. The thermal treatment apparatus according to claim 1, wherein
the treatment tank has a top surface where the supply port opens and a side surface, wherein
the protruded member is disposed so as to face the supply port of the hot air on the top surface in a vertical direction.

3. The thermal treatment apparatus according to claim 1, wherein
the treatment tank includes a top surface where the supply port opens and a side surface, wherein
a toner particle supply port is disposed on the side surface, and the toner particle supply port supplies toner particles supplied by the toner particle supply unit into the treatment chamber, wherein
a height of the toner particle supply port on the side surface is lower than a position of the upper end edge of the columnar member.

4. The thermal treatment apparatus according to claim 1, wherein
the treatment tank includes a top surface where the supply port opens and a side surface, wherein
a cold air supply port is disposed on the side surface, at a position lower than a toner particle supply port, and the cold air supply port supplies cold air supplied by a cold air supply unit into the treatment chamber, wherein
the treatment tank includes a collection unit to collect toner particles at a position lower than the cold air supply port.

5. The thermal treatment apparatus according to claim 1, wherein
the radius of curvature R (mm) at the tip of the protruded member is 5<R<45.

6. A thermal treatment apparatus comprising:
a treatment tank including a treatment chamber to perform thermal treatment on toner particles;
a toner particle supply unit configured to supply toner particles into the treatment chamber; and
a hot air supply unit including a supply port to supply hot air into the treatment chamber, wherein
the supply port of the hot air supply unit is disposed on a ceiling of the treatment chamber, wherein
an inclined surface exists on an outer periphery of the supply port of the hot air supply unit, and the inclined surface inclines downward in a direction toward an outer periphery portion of the treatment chamber.

7. The thermal treatment apparatus according to claim 6, wherein
the treatment tank has a top surface and a side surface, wherein
the inclined surface is a surface that connects the top surface and the side surface and inclines with respect to the top surface and the side surface respectively.

8. The thermal treatment apparatus according to claim 7, wherein
an angle θ(°) of the inclined surface formed with the top surface in a vertical cross-section is 10≤θ≤45.

9. The thermal treatment apparatus according to claim 7, wherein
the inclined surface is a surface linearly extending in a vertical cross-section.

10. The thermal treatment apparatus according to claim 7, wherein
a height of a boundary between the inclined surface and the side surface is lower than a position of the supply port of the hot air supply unit.

11. The thermal treatment apparatus according to claim 7, wherein
a toner particle supply port to supply toner particles, which are supplied by the toner particle supply unit, into the treatment chamber is disposed on the side surface.

12. The thermal treatment apparatus according to claim 11, wherein
the toner particle supply unit is for supplying toner particles into the treatment chamber by sending air flow toward inside of the treatment chamber, wherein
the side surface of the treatment chamber is a cylindrical surface, wherein
a horizontal direction component of a direction of the air flow supplied by the toner particle supply unit is a direction parallel with a tangential direction on a horizontal cross-section of the cylindrical surface.

13. The thermal treatment apparatus according to claim 12, wherein
the direction of the air flow supplied by the toner particle supply unit is a direction that has angle θT (°) downward from the horizontal direction and satisfies θT≤θ where θ is an angle of the inclined surface formed with the top surface of the treatment chamber.

14. The thermal treatment apparatus according to claim 6, wherein
the treatment tank includes a top surface and a side surface, wherein
a cold air supply port is disposed on the side surface, at a position lower than the toner particle supply port, and the cold air supply port supplies the cold air supplied by a cold air supply unit into the treatment chamber, wherein
the treatment tank includes a collection unit to collect toner particles at a position lower than the cold air supply port.

15. The thermal treatment apparatus according to claim 7, wherein
the treatment tank further comprises:
a columnar member that is disposed at the center inside of the treatment chamber in a vertical direction; and
a protruded member that is disposed at an upper end of the columnar member and has an approximately conical shape protruding toward the top surface, wherein
the columnar member has a cylindrical shape, wherein
a diameter of a circle, which is a boundary line between the top surface and the inclined surface, is the same size as a diameter of the columnar member.

16. A toner manufacturing method for manufacturing toner by performing thermal treatment on toner particles using a thermal treatment apparatus, wherein
the thermal treatment apparatus includes:
a treatment tank including a treatment chamber to perform thermal treatment on toner particles;
a toner particle supply unit configured to supply toner particles into the treatment chamber; and
a hot air supply unit including a supply port to supply hot air into the treatment chamber, wherein
the supply port of the hot air supply unit is disposed on a ceiling of the treatment chamber, wherein
the treatment tank further including:
a columnar member that is disposed at the center inside of the treatment chamber in a vertical direction; and
a protruded member that is disposed at an upper end of the columnar member and has an approximately conical shape protruding toward the ceiling, wherein
the columnar member has a cylindrical shape and a radius of curvature RCP (mm) of an upper end edge in a vertical cross-section thereof is 5<RCP<75.

17. A toner manufacturing method for manufacturing toner by performing treatment on toner particles using a thermal treatment apparatus, wherein
the thermal treatment apparatus includes:
a treatment tank including a treatment chamber to perform thermal treatment on toner particles;
a toner particle supply unit configured to supply toner particles into the treatment chamber; and
a hot air supply unit including a supply port to supply hot air into the treatment chamber, wherein
the supply port of the hot air supply unit is disposed on a ceiling of the treatment chamber, wherein
an inclined surface exists on an outer periphery of the supply port of the hot air supply unit, and the inclined surface inclines downward in a direction toward an outer periphery of the treatment chamber.
